(19) United States
(12) Patent Application Publication
(10) Pub. No.: US 2005/0108461 A1
(43) Pub. Date: May 19, 2005

(54) Memory apparatus having redundancy, and method for storing data

(75) Inventors: Sven Boldt, Aschheim (DE); Manfred Moser, Dachau (DE); Erwin Thalmann, Villach (AT)

Correspondence Address: Maginot, Moore & Beck;Suite 3000, Bank One Tower, 111 Monument Circle, Indianapolis, IN, 46204, US

(73) Assignee: Infineon Technologies AG, Munchen (DE)

(21) Appl. No.: 10/956,615

(22) Filed: Oct. 1, 2004

(30) Foreign Application Priority Data
Oct. 2, 2003 (DE) 103 45 978.2

(51) Int. Cl. G06F 12/00

(52) U.S. Cl. 711/5; 711/115

(57) ABSTRACT

The invention provides a memory apparatus having a memory module (100) (which has a memory bank (101a)), a controller processor unit, a control bus (104), an address bus (105) and a data bus (106) for interchanging data between the controller processor unit (102) and the memory module (100), the memory module also having at least one further memory bank (101b-101n) which can be activated by means of at least one bank selection signal (205a, 205b) which is provided by the controller processor unit (102) and is supplied via the control bus (104).

The present invention relates to a memory apparatus for storing data and relates, in particular, to a data memory apparatus having memory modules which are constructed from at least one database.

Specifically, the present invention relates to a memory apparatus for storing data, said apparatus having a memory module (which has a memory bank), a controller processor unit, a control bus for supplying control signals from the controller processor unit to the memory module, an address bus for supplying addressing signals from the controller processor unit to the memory module and a data bus for interchanging data between the controller processor unit and the memory module.

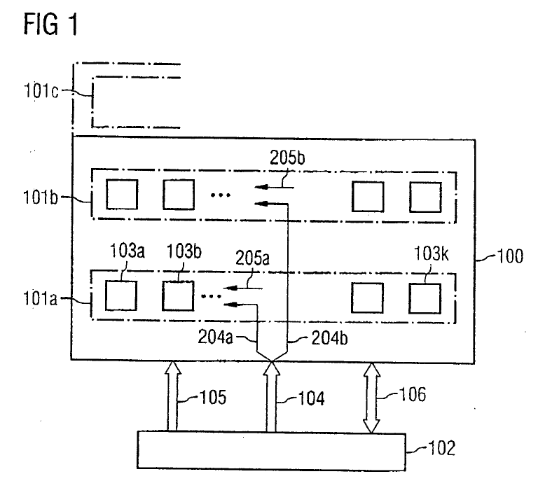

FIG. 1 shows a conventional memory apparatus having a memory module which is formed from a memory bank. The memory bank has one or more memory units in which data are stored.

For the purposes of storing data, a computer system supplies the memory module with addressing data via an address bus and with control data via a control bus. The computer system supplies the memory module with the addressing data and control data both when storing data in, and when reading data from, the memory module. A data bus is used to interchange data between the computer system and the memory module. Memory modules preferably comprise DRAM (Dynamic Random Access Memory) components and are preferably used as main memories in computer systems. Memory modules of this type have the advantage that they can be manufactured at low cost but have the disadvantage that the data stored in the memory modules have to be refreshed in accordance with prescribable refresh cycles (typically 64 ms). Use is currently made of memory modules having 64 data lines, specific memory systems being designed in such a manner that 72 data lines are provided, with 64 data lines being used to transmit the data to be stored and the remaining eight data lines being used for correction logic.

An arrangement of this type comprising memory units and correction logic memory units forms a memory bank. Increasing miniaturization makes it possible to operate, together with a computer system, a plurality of memory banks in a memory module in such a manner that the system's total main memory is increased.

The computer system provides bank selection signals in order to address specific memory banks. If a memory bank (shown in FIG. 3) within a memory module is defective, it is disadvantageously necessary in conventional memory apparatuses to manually exchange and replace the entire memory module so that a prescribed memory size can be maintained. If the memory module as a whole is not exchanged, the defective memory bank can disadvantageously no longer be used by the computer system. This results in the fundamental disadvantage that the system's memory size (i.e. main memory) is reduced.

In conventional computer systems, the bank selection signals are always associated with a specific memory bank.

DE 197 14 952 describes a method for managing memory modules, in which an error log exhibiting a time stamp for errors which occur during normal operation of the memory module is kept in a management memory in the memory module, the management memory permanently storing management information. This makes it possible to permanently store errors in memory modules and error logs but not to eliminate the error without manually exchanging the memory module, i.e. removing the memory module from the system and inserting a sound memory module into the system.

Therefore, it is an object of the present invention to provide a memory apparatus and a method for storing data, in which, once an error has occurred in a memory bank, the original memory size can be restored without exchanging the memory module.

This object is achieved according to the invention by means of a memory apparatus for storing data, said apparatus having the features of patent claim 1.

The object is also achieved by means of a method specified in patent claim 9.

Further refinements of the invention can be found in the subclaims.

A fundamental concept of the invention involves providing redundant memory banks on a memory module. Furthermore, expanding the memory module with a configurable logic unit makes it possible to combine existing bank selection signals in such a manner that one of the redundant memory banks in the memory module can be addressed, in particular when one of the memory banks which is in operation exhibitsan error.

The memory module is therefore expanded, said expansion making it possible to flexibly assign different memory banks in a memory module to the addressing options which can be selected in a system.

A fundamental advantage of the present invention is thus that the reliability of the overall system can be increased. The increasing technological miniaturization advantageously makes it possible to accommodate a plurality of memory banks in a memory module. Components are thus placed, for example, on both sides or above one another in such a manner that numerous memory banks can be accommodated in a memory module.

A computer system can normally support only a particular prescribed number of memory banks; the invention provides the memory module with a number of memory banks which exceeds the number of memory banks which can be supported.

A number of redundant memory banks which, in the event of an error occurring, can replace a defective memory bank are obtained in this manner.

A further advantage of the present invention is that the memory module is expanded in a form such that there is no need for any additional lines from the memory module to the computer system or to a controller processor unit. It is thus expedient that the inventive memory apparatus and the inventive method can be used in any conventional computer system. An interface to a computer system which is being used advantageously remains unchanged.

The advantage of the invention is, in particular, that the reliability of safety/security-critical computer systems is drastically increased, since it is possible to access redundant memory banks in memory modules. Furthermore, the inventive method makes it possible to repair memory modules without manual intervention or exchanging individual memory modules. An advantage of the present invention is, in particular, that the reliability of the overall system is increased.

The inventive memory apparatus for storing data essentially has:
a) a memory module which has a memory bank;
b) a controller processor unit;
c) a control bus for supplying control signals from the controller processor unit to the memory module;
d) an address bus for supplying addressing signals from the controller processor unit to the memory module; and
e) a data bus for interchanging data between the controller processor unit and the memory module, the memory module also having at least one further memory bank which can be activated by means of at least one bank selection signal which is provided by the controller processor unit and is supplied via the control bus.

Furthermore, the inventive method for storing data essentially has the following steps:
a) a memory module having a memory bank is provided;
b) control signals are supplied from a controller processor unit to the memory module via a control bus;
c) addressing signals are supplied from a controller processor unit to the memory module via an address bus; and
d) data are interchanged between the controller processor unit and the memory module via a data bus, at least one bank selection signal being provided by the controller processor unit and being supplied to the memory module via the control bus in such a manner that at least one further memory bank which is provided in the memory module is activated by means of the at least one bank selection signal.

The subclaims contain advantageous developments and improvements of the respective subject matter of the invention.

In line with one preferred development of the present invention, the controller processor unit has a test mode unit which is supplied with control signals via the control bus and with addressing signals via the address bus and which, on the basis of the control and addressing signals supplied, outputs a combinational logic signal for determining a logic combination for the bank selection signals.

In line with another preferred development of the present invention, the controller processor unit has a selection unit for selecting at least one memory bank in the memory module, the combinational logic signal output by the test mode unit and the bank selection signals being supplied to the selection unit.

In line with yet another preferred development of the present invention, the selection unit for selecting at least one memory bank in the memory module is formed by a logic circuit. The logic circuit in the selection unit for selecting at least one memory bank in the memory module is preferably constructed from NAND functions.

In line with yet another preferred development of the present invention, the at least one memory bank in the memory module is constructed from memory units.

In line with yet another preferred development of the present invention, the test mode unit and/or the selection unit is/are integrated, together with the memory module, in a single unit. The test mode unit and/or the selection unit is/are preferably located, together with the memory module, in the computer system or controller processor unit.

In line with yet another preferred development of the present invention, the controller processor unit provides a number of two bank selection signals for selecting at least a number of four memory banks.

In line with yet another preferred development of the present invention, the combinational logic signal output by the test mode unit and the bank selection signals are supplied, for a combinational logic operation, to the selection unit for selecting at least one memory bank in the memory module.

In line with yet another preferred development of the present invention, a test mode is used to assign the bank selection signals to at least one memory bank.

In line with yet another preferred development of the present invention, the controller processor system reacts dynamically to faulty memory banks and replaces them in the event ofan error.

Exemplary embodiments of the invention are explained in more detail in the description below and are shown in the drawings, in which:

FIG. 1 shows a block diagram of a memory apparatus having a memory module (which comprises memory banks) in line with one preferred exemplary embodiment of the present invention;

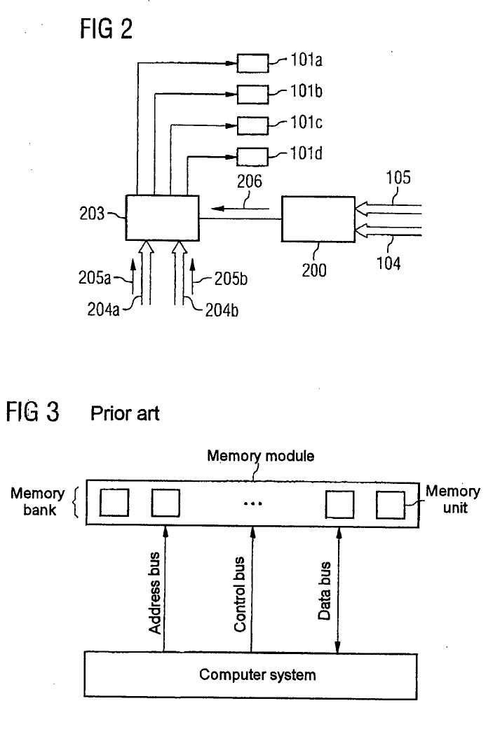

FIG. 2 shows circuit units which can be activated, on the basis of the bank selection signals and a combinational logic signal, for the purpose of selecting memory banks; and

FIG. 3 shows a conventional memory apparatus.

In the figures, the same reference symbols denote the same components or steps; or components or steps having the same function.

FIG. 1 shows a block diagram of a memory apparatus in line with one preferred exemplary embodiment of the present invention. The memory apparatus has a memory module 100 and a controller processor unit 102 which are connected to one another via a control bus 104, an address bus 105 and a data bus 106.

The control bus 104 is used to supply control signals from the controller processor unit 102 to the memory module 100, while the address bus 105 is used to supply addressing signals from the controller processor unit 102 to the memory module 100 in order to prescribe memory addresses when storing and/or reading data.

The data bus 106 is used to interchange data between the controller processor unit and the memory module.

The inventive memory apparatus has a memory module 100 which, in addition to a customary memory bank 101a (dot-dashed line), has at least one further memory bank 101b (. . . 101n) which is indicated by the dotted line. Bank selection signals 205a, 205b are supplied to the memory banks. It is conceivable, in principle, to supply each memory bank with its own bank selection signal 205a-205n. However, computer systems usually provide two bank selection signals 205a, 205b such that further memory banks can be addressed only by means of a logic selection unit (described below with reference to FIG. 2). The bank selection signals 205a, 205b are usually transmitted via the control bus 104.

Bank selection lines 204a, 204b are used for this purpose. Expanding the memory module in this manner now makes it possible to address different memory banks 101b-101c in addition to an already existing memory bank 101a. This results in a flexible assignment capability, as will be explained below with reference to FIG. 2.

FIG. 2 shows a test mode unit 200 and a selection unit 203 which may be arranged, for example, in the controller processor unit 102 (FIG. 1). The controller processor unit 102 supplies the test mode unit 200 with control data and addressing data via the control bus 104 and the address bus 105. Data of this type are used in the test mode unit 200 to generate a combinational logic signal 206 which indicates the manner in which the two bank selection signals 205a, 205b (described with reference to FIG. 1) are to be logically combined. The test mode unit 200 supplies the combinational logic signal 206 to the selection unit 203.

The following table shows an example of a logic combination for two bank selection signals 201a, 201b (which are denoted CS1, CS2 in the table) in order to address corresponding memory banks 101a-101n in a memory module 100, the numbers 1 . . . 4 being used to denote the memory banks in table 1.

TABLE 1

| | Memory | Memory | Memory | Memory |
|---|---|---|---|---|
| | bank 1 | bank 2 | bank 3 | bank 4 |
| CS1 | X | | | |
| CS2 | | (X)>>> | >>>X | |

Table 1 illustrates the rectification of a faulty state caused byan error in the memory bank 2. In a basic state of the memory apparatus, a bank selection signal CS1 activates the memory bank 1, while a bank selection signal CS2 activates the memory bank 2. By way of example, a correction logic unit has used parity tests, for example, to determinean error in the memory bank 2 in such a manner that the bank selection signal CS2 is now assigned to the memory bank 3 on the basis of the combinational logic signal 206. The memory bank 4 listed in table 1 continues to be available as a redundant memory bank, while the memory bank 2 is no longer addressed by the system, since it exhibitsan error.

Therefore, the advantage of the present invention can clearly be seen such that the controller processor system 102 can react dynamically to faulty memory banks, it being possible to replace faulty memory banks with sound memory banks at any time provided that there is sufficient redundancy in the system, i.e. provided that there are enough sound memory banks in the memory module 100. Increasing miniaturization of memory components makes it possible in any case to realize a plurality of memory banks in a memory module.

The bank selection signal 205a is supplied to the selection unit 203 via the bank selection line 204a, while the bank selection signal 205b is supplied to the selection unit 203 via the bank selection line 204b.

It should be pointed out that the selection unit 203 contains a logic circuit for logically combining the signals which have been supplied, i.e. the combinational logic signal 206 and the corresponding bank selection signals 205a, 205b, logic circuits of this type being formed, for example, by means of NAND functions, as are known by those skilled in the art. Memory modules usually have 72 data lines, eight of which are used by the computer system for parity checks.

This ensures that data are not changed when transmitted between the memory module 100 and the computer system or controller processor unit 102, or in the memory module 100 itself. In the event of an error, the system can repeat a storage operation. It is furthermore possible to react dynamically to faulty memory banks in such a manner that, when the system establishes that the number of data errors occurring is increasing, a faulty memory bank is determined.

When a prescribed number oferrors has been exceeded, the system can automatically replace the faulty memory bank with a redundant memory bank. In this case, there is advantageously no need for external intervention, thus increasing the reliability of the overall system. This increases system reliability without having to increase the number of bank selection signals.

Reference is made to the introduction to the description with regard to the conventional memory apparatus shown in FIG. 3.

Although the present invention was described above with reference to preferred exemplary embodiments, it is not restricted thereto but rather can be modified multifariously.

Nor is the invention restricted to the application options mentioned.

List of Reference Symbols

In the figures, the same reference symbols denote the same components or steps, or components or steps having the same function.
100 Memory module
101a-101n Memory bank
102 Controller processor unit
103a-103k Memory unit
104 Control bus
105 Address bus
106 Data bus
200 Test mode unit
201 First bank selection signal
202 Second bank selection signal
203 Selection unit
204a-204n Bank selection line
205a-205l Bank selection signal
206 Combinational logic signal

1-13. (canceled)

14. A memory apparatus for storing data, said apparatus having:
a) a memory module comprising a first memory bank and at least one further memory bank;
b) a controller processor unit operable to select the at least one further memory bank based on at least one bank selection signal;
c) a control bus configured to supply control signals from the controller processor unit to the memory module, said control bus further operable to provide signals from the controller processor unit to the memory module that effect selection of the at least one further memory bank;
d) an address bus configured to supply addressing signals from the controller processor unit to the memory module; and
e) a data bus configured to interchange data between the controller processor unit and the memory module.

15. The memory apparatus as claimed in claim 14, wherein the controller processor unit includes a test mode unit configured to receive control signals via the control bus and addressing signals via the address bus, the test mode unit operable to generate a combination logic signal based on the control signals and addressing signals, and wherein the controller processor unit is further operable to select the at least one further memory bank based in part on the combination logic signal.

16. The memory apparatus as claimed in claim 15, wherein the controller processor unit further comprises a selection unit configured to select at least one further memory bank in the memory module based on the combinational logic signal and the at least one bank selection signal.

17. The memory apparatus as claimed in claim 16, wherein the selection unit comprises a logic circuit.

18. The memory apparatus as claimed in claim 17, wherein the selection unit includes logical NAND devices.

19. The memory apparatus as claimed in claim 14, wherein the at least one further memory bank in the memory module comprises a plurality of memory units.

20. The memory apparatus as claimed in claim 15, wherein the test mode unit is integrated with the memory module as a single unit.

21. The memory apparatus as claimed in claim 16, wherein the test mode unit and the selection unit are integrated with the memory module as a single unit.

22. The apparatus as claimed in claim 14, wherein the controller processor unit is further operable to select at least one of the first memory bank and three further memory banks based on two bank selection signals.

23. A method for storing data, said method comprising:
a) providing a memory module having a memory bank and at least one further memory bank;
b) supplying control signals from a controller processor unit to the memory module via a control bus;
c) supplying addressing signals from the controller processor unit to the memory module via an address bus;
d) interchanging data between the controller processor unit and the memory module via a data bus; and
e) providing at least one bank selection signal to the memory module via the control bus and activating the at least one further memory bank on the basis of the at least one bank selection signal.

24. The method as claimed in claim 23, wherein step e) further comprises activating the at least one further memory bank on the basis of the at least one bank selection signal, the control signals, and the addressing signals.

25. The method as claimed in claim 24, wherein step e) further comprises generating a combination logic signal based on the control signals and the addressing signals, and activating the at least one further memory bank on the basis of the at least one bank selection signal and the combination logic signal.

26. The method as claimed in claim 23, wherein step e) further comprises assigning the bank selection signals to one of the memory bank and the at least one further memory bank.

27. The method as claimed in claim 26, wherein step e) further comprises assigning the bank selection signals based on identification of at least one faulty memory bank in the memory module.

28. A memory apparatus for storing data, said apparatus having:
a) a memory module comprising a plurality of memory banks, each of the plurality of memory banks activated via a corresponding bank selection line;
b) a control bus configured to supply control signals from a controller processor unit to the memory module,
c) an address bus configured to supply addressing signals from the controller processor unit to the memory module; and
d) a data bus configured to interchange data between the controller processor unit and the memory module.
e) a first circuit operably configured to receive at least one bank selection signal from the controller processor unit and activate at least one of the plurality of memory banks via at least one of the bank selection lines responsive to the at least one bank selection signal.

29. The memory apparatus of claim 28 wherein the first circuit is operably configured to receiving control signals and addressing signals, and wherein the first circuit is operable to activate at least one of the plurality of bank selection lines based at least in part on the at least one bank selection signal, the control signals and the addressing signals.

30. The memory apparatus of claim 28, wherein the first circuit includes a selection unit operable to receive control signals and addressing signals and generate a combinational logic signal therefrom, and wherein the first circuit is operable to activate at least one of the plurality of bank selection lines based on the combination logic signal.

31. The memory apparatus of claim 30, wherein the first circuit is integrated with the memory module as a unit.

32. The memory apparatus of claim 29, wherein the first circuit is integrated with the memory module as a unit.

33. The memory apparatus of claim 28, wherein the first circuit is integrated with the memory module as a unit.
